(19) United States
(12) Patent Application Publication
(10) Pub. No.: US 2019/0017657 A1
(43) Pub. Date: Jan. 17, 2019

(54) FILAMENT TYPE LED LIGHT SOURCE AND LED LAMP

(71) Applicant: SAMSUNG ELECTRONICS CO., LTD., Suwon-si (KR)

(72) Inventors: Dong Ho KIM, Yongin-si (KR); Pun Jae CHOI, Yongin-si (KR)

(21) Appl. No.: 15/908,993

(22) Filed: Mar. 1, 2018

(30) Foreign Application Priority Data
Jul. 14, 2017 (KR) 10-2017-0089355

(51) Int. Cl. F21K 9/232; H05B 33/08; F21S 4/28

(52) U.S. Cl. CPC F21K 9/232; F21S 4/28; H05B 33/0857

(57) ABSTRACT

A filament type light emitting diode (LED) light source includes a plurality of LED modules, a coupler, and a common connection portion. The LED modules are in a polygonal prism structure and emit white light having different color temperatures or light of different wavelengths. Each LED module having a bar shape at a respective side surface of the polygonal prism structure and includes a first connection electrode and a second connection electrode. The coupler couples the LED modules to maintain the polygonal prism structure. The common connection portion is at one end of the polygonal prism structure and is commonly connected to the second connection electrode of each of the LED modules.

### CROSS-REFERENCE TO RELATED APPLICATION

Korean Patent Application No. 10-2017-089355 filed on Jul. 14, 2017, and entitled, “Filament Type LED Light Source and LED Lamp,” is incorporated by reference herein in its entirety.

### BACKGROUND

### 1. Field

One or more embodiments described herein relate to a filament type LED light source and an LED lamp using the same.

### 2. Description Of the Related Art

In recent years, incandescent bulbs and fluorescent lamps have been replaced by light emitting diode (LED) lighting devices. LED lighting devices have excellent controllability, fast response speeds, high electro-optical conversion efficiency, long lifespans, low power consumption, and high luminance characteristics. Especially, bulb-type LED lamps have come to prominence. LED lighting devices are able to emit light of various colors and thus are suitable for use in many systemized illumination light source applications, domestically and otherwise. Also, in recent years, light has been found to affect biorhythms and emotions of the residents of domestic spaces.

### SUMMARY

In accordance with one or more other embodiments, a filament type light emitting diode (LED) light source includes a plurality of LED modules arranged in a polygonal prism structure, the plurality of LED modules to emit white light having different color temperatures or light of different wavelengths, each of the plurality of LED modules having a bar shape at a respective side surface of the polygonal prism structure and including a first connection electrode and a second connection electrode; a coupler to couple the plurality of LED modules in order to maintain the polygonal prism structure; and a common connection portion at one end of the polygonal prism structure and commonly connected to the second connection electrode of each of the plurality of LED modules.

In accordance with one or more other embodiments, an LED lamp includes a base portion having an external connection terminal; a light-transmitting cover mounted on the base portion and having an internal space; at least one filament type LED light source in the internal space and having a polygonal prism structure including a plurality of LED modules, the plurality of LED modules to emit white light having different color temperatures or light of different wavelengths, each of the plurality of LED modules coupled at a respective side surface of the polygonal prism structure and having a first connection electrode and a second connection electrode; a power supply, in the base portion, to supply power to the plurality of LED modules; and a driving controller, in the base portion, to control the power supply to allow at least one of the plurality of LED modules to be selectively driven

The at least one filament type LED light source includes a coupler to couple the plurality of LED modules in order to maintain the polygonal prism structure, a plurality of first connection portions at a first end of the polygonal prism structure and respectively connected to the first connection electrode of each of the plurality of LED modules and connected to the driving controller, and a second connection portion at a second end of the polygonal prism structure and commonly connected to the second connection electrode of each of the plurality of LED modules and connected to the driving controller.

In accordance with one or more other embodiments, an LED lamp includes a base portion having an external connection terminal; a light-transmitting cover mounted on the base portion, and having an internal space; a reflective prism arranged along a central axis of the light-transmitting cover and having a common electrode formed in a direction of the central axis; a plurality of filament type LED light sources around the reflective prism of the internal space, each of the plurality of filament type LED light sources including a plurality of LED modules arranged in a polygonal prism structure, the plurality of filament type LED light sources to emit white light having different color temperatures, each of the plurality of LED modules coupled at a respective side surface and having a first connection electrode and a second connection electrode; a power supply, in the base portion, to supply power to the plurality of LED modules of each of the plurality of filament type LED light sources; and a driving controller, in the base portion, to control the power supply to allow at least one of the plurality of LED modules to be selectively driven in each of the plurality of filament type LED light sources.

Each of the plurality of LED filament light sources includes a plurality of first connection portions at a first end of the polygonal prism structure and respectively connected to the first connection electrode of each of the plurality of LED modules and connected to the power supply, and a second connection portion at a second end of the polygonal prism structure and commonly connected to the second connection electrode of each of the plurality of LED modules and connected to the power supply portion through the common electrode.

### BRIEF DESCRIPTION OF THE DRAWINGS

Features will become apparent to those of skill in the art by describing in detail exemplary embodiments with reference to the attached drawings in which:

FIGS. 1 and 2 illustrate an embodiment of an LED lamp;

FIG. 3 illustrate an exploded perspective view of the LED lamp of FIG. 1;

FIG. 4 illustrates an example of a filament type LED light source;

FIG. 5 illustrates a circuit embodiment of a power supply;

FIG. 6 illustrates an embodiment of an LED module;

FIG. 7 illustrates an embodiment of an LED chip;

FIGS. 8 and 9 illustrate additional embodiments of LED modules;

FIG. 10 illustrates another embodiment of a filament type LED light source; and

FIG. 11 illustrates another embodiment of an LED lamp.

### DETAILED DESCRIPTION

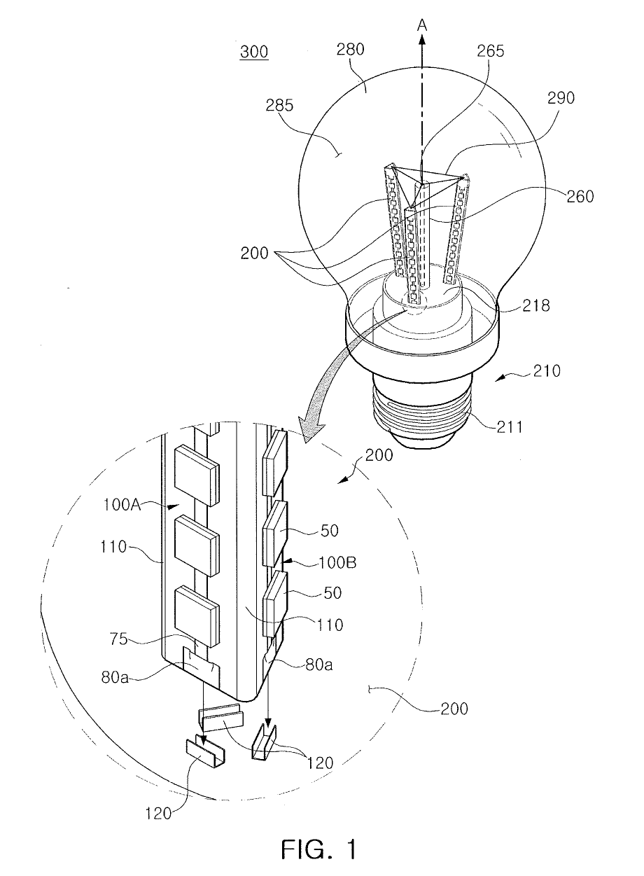

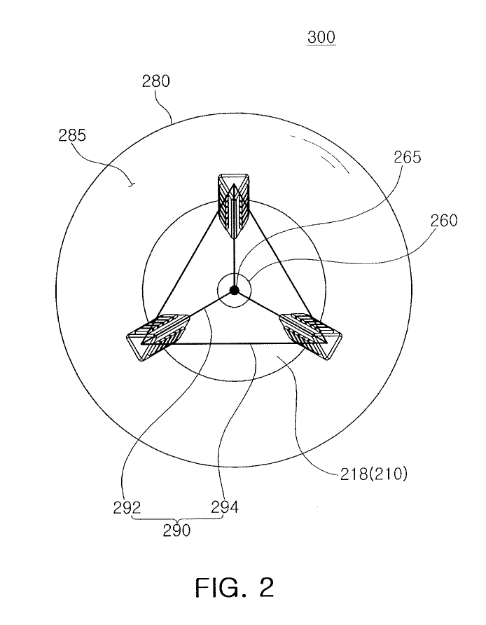

FIGS. 1 and 2 illustrate perspective and top plan views of an embodiment of an LED lamp 300, and FIG. 3 illustrates an embodiment of exploded perspective view of the LED lamp 300 of FIG. 1.

Referring to FIGS. 1, 2, and 3 an LED lamp 300 may include a base portion 210 having an external connection terminal 211, a light-transmitting cover 280 mounted on the base portion 210 and having an internal space 285, and a plurality of filament type LED light sources 200 in the internal space 285.

The light-transmitting cover 280 may be a bulb-type cover formed of a light-transmitting material. For example, the light-transmitting material may be a transparent, milky, matte, or colored cover formed of a glass, a hard glass, a quartz glass, or a light transmitting resin. The bulb shape may be, for example, A-type, G-type, R-type, PAR-type, T-type, S-type, candle-type, P-type, PS-type, BR-type, ER-type, or BRL-type bulb shape.

The light-transmitting cover 280 may be coupled to the base portion 210 using a connection portion 281. The connection portion may be implemented, for example, as a simple coupling structure, e.g., a screw coupling structure or a stop protrusion structure.

The base portion 210 is coupled to the light-transmitting cover 280 to form an outer cover of the LED lamp 300. The external connection terminal 211 is on the base portion 210 and may be a socket having a standard according to the related art in order to replace a lighting device according to the related art. For example, the external connection terminal 211 may be formed of a E40. E27, E26, E14, GU, B22, BX, BA, EP, EX, GY, GX, GR, GZ or G-type socket.

Power applied to the LED lamp 300 may be supplied through the external connection terminal 211. As illustrated in FIG. 3, the base portion may include a housing 215 having a mounting space 217 and a top plate 218. The housing 215 has a screw coupling portion 212 and may be coupled to the external connection terminal 211 using the screw coupling portion 212. In one embodiment, the base portion 210 may be implemented as a single body rather than a structure formed using an assembly method or may be coupled to other additional elements to be configured.

A reflective prism 260 may be arranged along a substantially central axis A of the internal space 285 of the light-transmitting cover 280. The reflective prism 260 may be a white prism or may have a reflective surface formed of a reflective metal such as aluminum or silver. The reflective metal may only be applied to the surface of a prism formed of a different material or may be used as a material forming a prism itself. The reflective prism 260 may be mounted on the top plate 218 of the base portion 210.

The plurality of filament type LED light sources 200 may be arranged at regular intervals (or symmetrically) around the reflective prism 260. The plurality of filament type LED light sources 200 may be mounted on the top plate 218 of the base portion 210 in a manner similar to the reflective prism 260.

As illustrated in FIG. 2, the plurality of filament type LED light sources 200 may be mounted in an upwardly expanding direction and may have various shapes and may provided in various numbers, for example, based on the shape of the light-transmitting cover 280, light distribution characteristics, and/or light output requirements. In an example embodiment, three filament type LED light source 200 may be provided. In one embodiment, a different number of filament type LED light sources may be provided, e.g., one, two, or more than three.

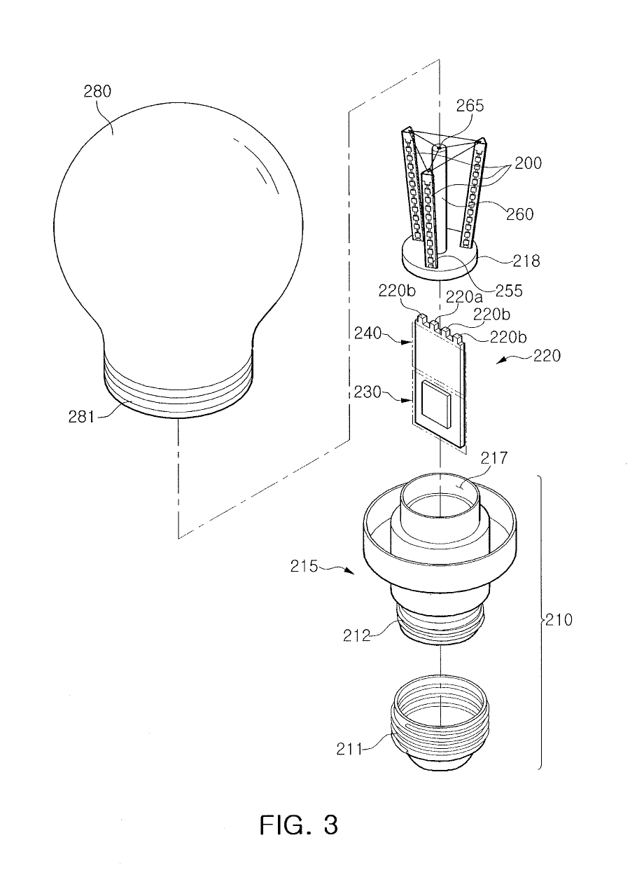

FIG. 4 illustrates an embodiment of the filament type LED light source 200 having a triangular prism structure formed of three LED modules 100A, 100B, and 100C. Each of the three LED modules 100A, 100B, and 100C has a bar shape and may correspond to a different side surface of the triangular prism structure.

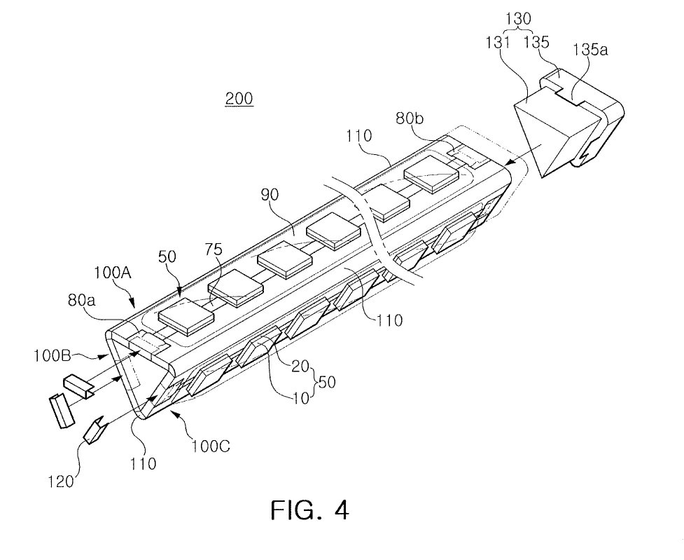

Referring again to FIG. 3, the base portion 210 may include a power supply portion 240 that supplies power to the plurality of LED modules 100A, 100B, and 100C, and a driving controlling portion 230 that controls the power supply portion. The power supply portion 240 may include, for example, an AC-DC converter (e.g. 231 in FIG. 5) for converting current from an external connection terminal to an appropriate current.

In an example embodiment, the driving controlling portion 230 is implemented in module form. An example of the form in which the power supply portion and driving controlling portion 230 are implemented on a single circuit board is illustrated in FIG. 3. The driving controlling portion may be implemented on a plurality of circuit boards or in a different form in other embodiments.

Referring again to FIG. 4, the filament type LED light source 200 may allow the three LED modules 100A, 100B, and 100C to be fixed using a coupling member 110, to thereby maintain a triangular prism structure.

In an example embodiment, the coupling member 110 may be located in an edge of a side surface of the triangular prism structure, in order to allow adjacent LED modules to be coupled to each other. The triangular prism structure may have a hollow center to allow heat generated from the LED modules 100A, 100B, and 100C to be easily released. The coupling member 110 may be made from a material having bonding properties. For example, the coupling member 110 may be an adhesive polymer, e.g., silicone resin, epoxy resin, polyacrylate, polyimide, polyamide, or benzocyclobutene (BCB).

In an example embodiment, each of the three LED modules 100A, 100B, and 100C may include a wavelength conversion film 10 that includes a combination of an LED chip emitting blue light and a phosphor for white light. The phosphor for each of the LED modules 100A, 100B, and 100C may be the same or different. Thus, color temperatures of white light may be differently configured. For example, the three LED modules 100A, 100B, and 100C may emit white light in the ranges of 2300 K to 3000 K, 3700 K to 4300 K, and 6400 K to 7000 K, respectively.

In an example embodiment, the connection structure of the filament type LED light source 200 and the driving controlling portion 230 may allow the three LED modules 100A, 100B, and 100C (that emit white light of different color temperatures) to be selectively driven in the filament type LED light source 200. Through selective driving, the LED lamp 300 may adjust the color temperature of illumination light to meet certain applications or requirements, e.g., in accordance with or to promote certain emotions of a user.

First, with respect to a connection structure of the filament type LED light source 200, as illustrated in FIG. 4 the filament type LED light source 200 may include three first connection portions 120 respectively connected to first connection electrodes 80a of the three LED modules 100A, 100B, and 100C, and a second connection portion 130 (a common connection portion) commonly connected to second connection electrodes 80b of the three LED modules 100A, 100B, and 100C.

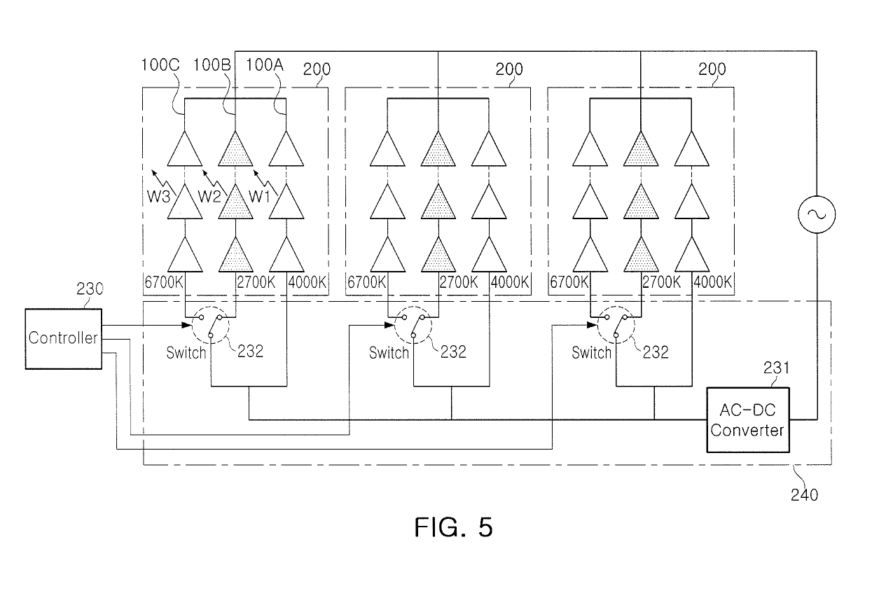

As illustrated in FIG. 4, the first connection portion 120 may be at a first end of a triangular prism structure. The first connection portion 120 may be provided in the form of a clip inserted or located on one end of a metal substrate 60 (e.g., see FIG. 6). The first connection portion 120 is in the form of a clip as illustrated in FIG. 1 and is mounted on the top plate 218 of the base portion 210. Thus, the first connection portion 120 may be used as a support fixing the filament type LED light source 200. In an example embodiment, the three LED modules 100A, 100B, and 100C are provided in each of the three filament type LED light sources 200, so the first connection portion 120 in the form of a clip may be provided as a total of nine first connection portions on the top plate 218 of the base portion 210.

The second connection portion 130 may oppose the first connection portion 120, that is, at a second end of a triangular prism structure. The second connection portion 130 may have a protrusion portion 131 inserted into an insertion hole of a triangular prism structure, and an electrode portion 135 connected to the protrusion portion 131 to be commonly connected to a second connection electrode 80b. When the protrusion portion 131 is inserted, the electrode portion 135 may have an extended portion 135a that is to be connected to the second connection electrode 80b.

In another embodiment, the first connection portion 120 and the second connection portion 130 may have another connection structure that are respectively connected to the first connection electrode 80a and commonly connected to the second connection electrode 80b.

As illustrated in FIGS. 1 through 3, the reflective prism 260 of the filament type LED light source 200 may include a common electrode 265. The reflective prism 260 may include the common electrode 265 in the form of an inner core. In one embodiment, the reflective prism 260 itself may be formed as a reflective metal and provided as a common electrode.

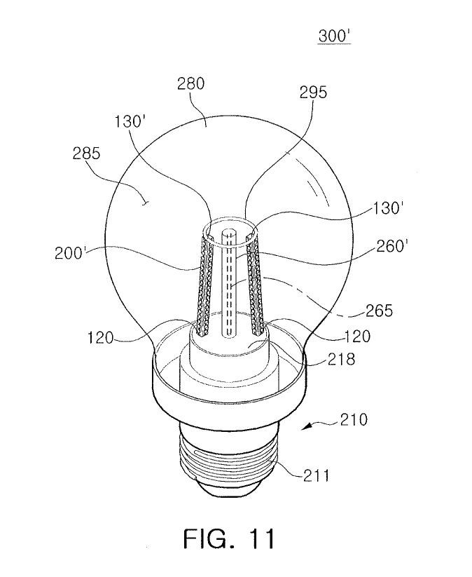

Referring to FIGS. 1 and 2, the filament type LED light source 200 is clip-fixed to the first connection portion 120 prepared in the top plate 218 of the base portion 210, as previously illustrated. Thus, the second connection portion 130 may be arranged upwardly. The second connection portion 130 may be connected to the common electrode 265 of the reflective prism 260 through a wire 292. For structural stability, the second connection portion 130 of each of the three filament type LED light sources 200 may be connected by a wire 294. The wires 292 and 294 related to the second connection portion 130 may be replaced by a conductive frame structure (e.g., referring to FIG. 11).

The common electrode 265 may allow the second connection portion 130 of each of the three filament type LED light sources 200 to be connected to a circuit substrate 220 (e.g., power supply portion 240) mounted on the base portion 210. For example, a connection terminal of the power supply portion 240 may be formed in a first protrusion 220a of the circuit substrate 220 and inserted into a groove of the top plate 218 of the base portion 210, in order to allow the power supply portion 240 and the common electrode 265 to be connected to each other. Such connection may be variously modified. In one example, the common electrode 265 is extended to the power supply portion 240 in the base portion 210 and connected to a connection terminal of the power supply portion 240.

The first connection portion 120 in the top plate 218 of the base portion 210 may also be connected to the circuit substrate 220 (e.g., power supply portion 240) mounted on the base portion 210. In one embodiment, the first connection portion 120 may be respectively connected to a connection terminal of the power supply portion 240 through a circuit in the top plate 218 of the base portion 210. As illustrated in FIG. 3, a connection terminal of the power supply portion 240 may be formed in a second protrusion 220b of the circuit substrate 220 that is to be fastened to a groove of the top plate 218 of the base portion 210, thereby being connected to a circuit related to the first connection portion 120.

As described previously, in three filament type LED light sources, the first connection electrode 80a of each of a total (nine) of LED modules is respectively connected to the power supply portion 240 through the first connection portion 120, and the second connection electrode 80b of each of a total (nine) of LED modules is commonly connected to the power supply portion 240 through the second connection portion 130 and the common electrode 265.

FIG. 5 illustrates a circuit embodiment of the three filament type LED light sources 200, each including LED modules 100A, 100B, and 100C. For example, the first LED module 100A, the second LED module 100B, and the third LED module 100C may emit white light W1 at 4000 K, white light W2 at 2700 K, and white light W3 at 6700 K, respectively.

When power is applied, the first LED module 100A in each of the filament type LED light sources 200 always emits the white light W1 at 4000 K in a normally-on state. The second LED module 100B and the third LED module 100C may be selectively switched (e.g., by switches 232), e.g., one of the white light W2 at 2700 K and the white light W3 at 6700 K may be selected to adjust color temperature. Such switching control may be implemented, for example, through the driving controlling portion (controller) 230. With respect to white light (for example, W1) selectively switched, the number (0 to 3) of an LED module (for example, 100B) having been driven is adjusted, so color temperature may be accurately controlled.

In one example embodiment, a duty ratio of a switching control signal with respect to the second LED module 100B and the third LED module 100C is adjusted in the driving controlling portion 230, so color temperature of white light may be further accurately controlled.

In one example, the driving controlling portion 230 may include a communications module. The communications module may be, for example, a wireless communications module using ZigBee®, WiFi, or LiFi. Using a smartphone or a wireless controller, selective switching (e.g., as described previously) may be controlled through a communications module, and color temperature of the LED lamp 300 may be controlled through such selective switching.

As described above, while the power supply portion 240 supplies power to one or more of the LED modules (e.g., the first LED module 100A) in each of the filament type LED light sources 200, the driving controlling portion 230 controls the power supply portion 240 to selectively supply power to one or more of remaining LED modules (e.g., second LED module 100B and/or third LED module 100C) to control color temperature.

In the example embodiment described previously, power is always supplied to one of the LED modules and power is selectively supplied to remaining ones of the LED modules for purposes of controlling color temperature. In one embodiment, two or all LED modules in each of the filament type LED light sources 200 may be selectively switched, so color temperature may be adjusted in a wide range.

In the example embodiment described previously, only the case in which color temperature is adjusted is illustrated. In one example embodiment, the color of illumination light may be adjusted. For example, a plurality of LED modules forming a filament type LED light source may emit light of different wavelengths to adjust the level of illumination light. For example, in the example embodiment described previously, the first LED module 100A may emit white light and the second LED module 100B and the third LED module 100C may emit red light and blue light, respectively. Thus, through selective switching of the second LED module and the third LED module, the color of illumination light may be adjusted.

In one or more embodiments, the LED modules are provided in a bar configuration in each of the filament type LED light sources.

FIG. 6 illustrates an embodiment of a side cross-sectional view of LED module 100A, which, for example, may be employed in the filament type LED light source 200 of FIG. 4.

Referring to FIG. 6, the LED module 100A may include a metal substrate 60 and a plurality of light emitting diode (LED) chips 50. The metal substrate may have a bar shape. The plurality of light emitting diode (LED) chips 50 are mounted on the metal substrate 60 and are electrically connected to each other.

In one embodiment, the metal substrate 60 may be advantageous for heat radiation and may induce forward light emission. For example, the metal substrate 60 may be a SUS or Al substrate. An insulating layer 72 may be on the metal substrate 60, and a circuit pattern 75 for connecting the plurality of LED chips 50 may be formed in the insulating layer 72.

The circuit pattern 75 may connect the plurality of LED chips 50 in series. The LED module 100A may include a first connection electrode 80a and a second connection electrode 80b at respective ends of the metal substrate 60 and connected to respective circuit patterns 75. The LED module 100A may further include a transparent resin portion 90 on an upper surface of the metal substrate 60 to cover the plurality of LED chips 50.

The LED chip 50 illustrated in FIG. 6 may include a wavelength conversion film 10 in one surface of a semiconductor stack 20 and may include at least one phosphor P. As described previously, the wavelength conversion film 10 of the LED module 100A may be configured differently from the wavelength conversion film 10 of one or more remaining LED modules 100B and 100C of a filament type LED light source.

The wavelength conversion film 10 of each of the LED modules 100A, 100B, and 100C may emit, for example, white light having different color temperatures. In one embodiment, the wavelength conversion film may emit light of different wavelengths. When light of different colors are to be emitted, while a wavelength conversion portion is not introduced, the LED chip 50 itself may emit light of a corresponding color.

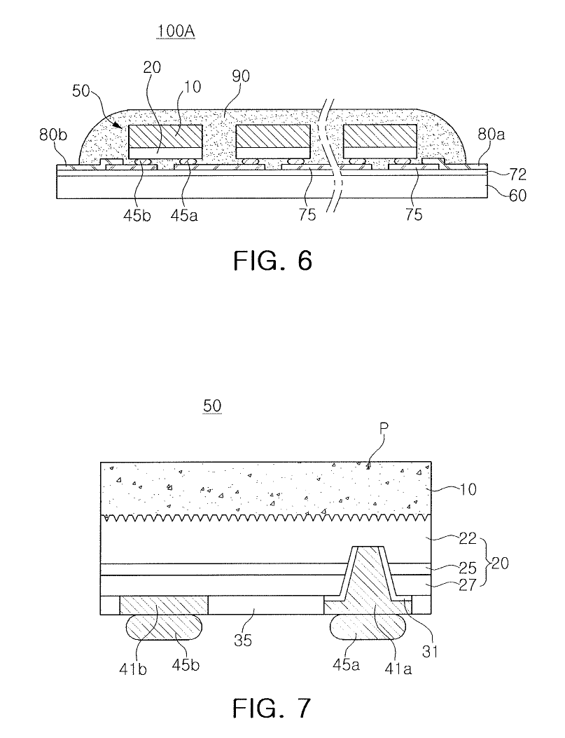

FIG. 7 illustrates a side cross-sectional view of an embodiment of the LED chip 50, provided, for example, in the LED module of FIG. 6. Referring to FIG. 7, the LED chip 50 may have, for example, a chip scale package (CSP) as illustrated in FIG. 6 and may be a wafer level package (WLP).

The LED chip 50 may include a semiconductor stack 20 having a first conductivity-type semiconductor layer 22, an active layer 25, a second conductivity-type semiconductor layer 27, and a wavelength conversion film 10 on a light emitting surface of the semiconductor stack 20.

The first conductivity-type semiconductor layer 22 and the second conductivity-type semiconductor layer 27 may be, for example, an n-type semiconductor layer and a p-type semiconductor layer. respectively. The first conductivity-type semiconductor layer 22 and the second conductivity-type semiconductor layer 27 may be formed of a nitride semiconductor, for example, a material having a composition of AlₓIn_{y}Ga_{1-x-y}N (0≤x≤1, 0≤y≤1, 0≤x+y≤1). Each layer may be formed of a single layer, but may have a plurality of layers with different characteristics such as doping concentration, composition, or the like in another embodiment. In one example embodiment, the first conductivity-type semiconductor layer 22 and the second conductivity-type semiconductor layer 27 may include an AlInGaP or AlInGaAs-based semiconductor material, in addition to the nitride semiconductor material.

The active layer 25 is between the first conductivity-type semiconductor layer 22 and the second conductivity-type semiconductor layer 27, and may have a multiple quantum well (MQW) structure, e.g., a quantum well layer and a quantum barrier layer that are alternately stacked. For example, when the active layer is a nitride semiconductor, a GaN/InGaN structure may be used. In one example embodiment, a single quantum well(SQW) structure may be used.

An unevenness portion is formed in a light emitting surface of the semiconductor stack 20 (e.g., a surface of the first conductivity-type semiconductor layer 22) to improve light extraction efficiency. The unevenness portion may be formed, for example, by wet etching the first conductivity-type semiconductor layer 22 after a substrate for growth is removed from the semiconductor stack 20, or by dry etching using a plasma.

In an example embodiment, a first electrode 41a may be formed to pass through the second conductivity-type semiconductor layer 27 and the active layer 25 and may be electrically connected to the first conductivity-type semiconductor layer 22. An insulating film 31 may be formed around the first electrode 41a to electrically isolate the first electrode 41a from the second conductivity-type semiconductor layer 27 and the active layer 25. A second electrode 41b may be formed on the second conductivity-type semiconductor layer 27. The first electrode 41a and the second electrode 41b may include, for example, one or more of silver (Ag), aluminum (Al), nickel (Ni), chromium (Cr), copper (Cu), gold (Au), palladium (Pd), platinum (Pt), tin (Sn), tungsten (W), rhodium (Rh), iridium (Ir), ruthenium (Ru), magnesium (Mg), zinc (Zn), titanium (Ti), or alloys thereof

An insulating structure 35 may be formed on the second conductivity-type semiconductor layer 27, in order to expose the first electrode 41a and the second electrode 41b. The LED chip 50 may further include a first bump 42a connected to the first electrode 41a and a second bump 42b connected to the second electrode 41b.

In one embodiment, the LED chip may have a structure different from a CSP structure or a form in which a wavelength conversion film is directly introduced to a chip (referring to FIG. 9).

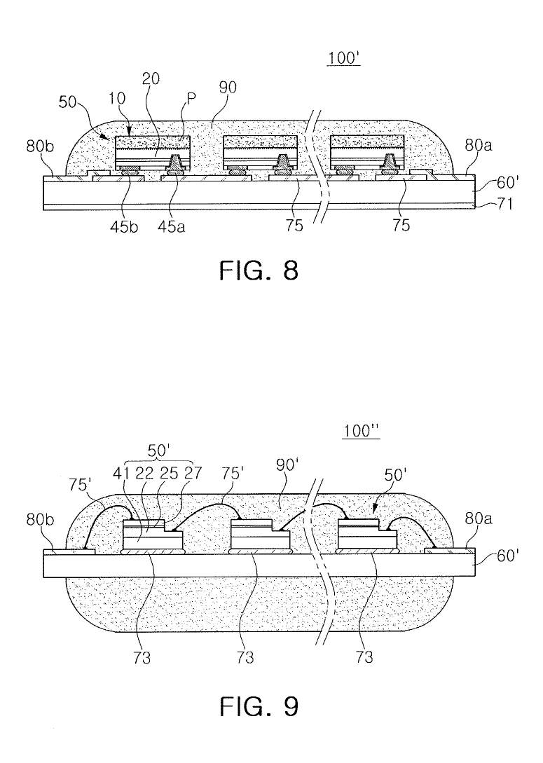

FIGS. 8 and 9 are side cross-sectional views of additional embodiments of an LED module, which, for example, may be employed in a filament type LED light source.

Referring to FIG. 8, an LED module 100′ may include a transparent substrate 60′ having a bar shape, and a plurality of LED chips 50 mounted on the transparent substrate 60′ and electrically connected to each other. Each LED chip 50 may correspond to CSP-type LED illustrated, for example, in FIG. 7 and may have a wavelength conversion film 10 provided in an individual chip.

The transparent substrate 60′ may have a reflective layer 71 in a lower surface to induce forward light emissions. For example, the transparent substrate 60′ may be formed of glass, hard glass, quartz glass, transparent ceramic, or sapphire. When the transparent substrate 60′ is formed of an insulating material, the circuit pattern 75 for connecting the plurality of LED chips 50 may be directly formed on an upper surface of the transparent substrate 60′.

Referring to FIG. 9, an LED module 100″ may include a transparent substrate 60 having a bar shape, a plurality of LED chips 50′ mounted on the transparent substrate 60′ and electrically connected to each other, and a wavelength conversion portion 90′ surrounding the plurality of LED chips 50′.

Each LED chip 50′ may include a first conductivity-type semiconductor layer 22, an active layer 25, and a second conductivity-type semiconductor layer 27, sequentially disposed on a light-transmitting substrate 41, in a manner different from the example embodiment described previously.

The plurality of LED chips 50′ may be mounted on the transparent substrate 60′, for example, using an adhesive layer 73. The transparent substrate 60′ may not have a separate circuit pattern, besides a first connection electrode 80a and a second connection electrode 80b, and the plurality of LED chips 50′ may be connected to each other in series by a wire 75′.

In an example embodiment, because a transparent substrate is used without a separate reflective layer, light generated from the LED chip 50′ may even be emitted to a lower surface of the transparent substrate 60′. The wavelength conversion portion 90′ may cover not only an upper surface of the transparent substrate 60′, on which the LED chip 50′ is mounted, but also a lower surface. In an example embodiment, the wavelength conversion portion 90′ may surround the transparent substrate 60′ while covering the LED chip 50′ on an upper surface of the transparent substrate 60′.

Thus, all of the light L emitted in an upper direction and a lower direction of the LED module 100″, according to an example embodiment, may be converted to desired light by the wavelength conversion portion 90′. As described previously, the wavelength conversion portion 90′ may include a combination of different phosphors according to the LED module 100″, so the wavelength conversion portion may emit light having a color temperature different from that of another LED module.

According to the example embodiments, the filament type LED light source has a triangular prism structure with three LED modules. In one embodiment, the filament type LED light source may have different structure, including but not limited to a polygonal prism structure with four or more LED modules.

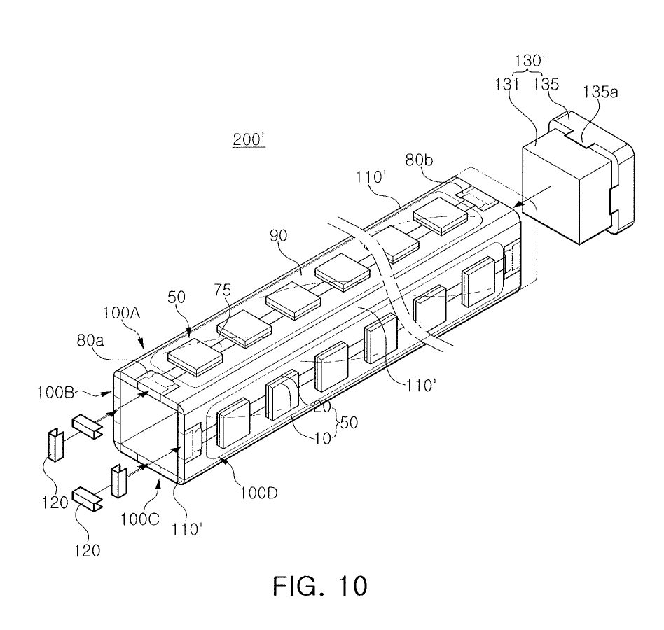

FIG. 10 illustrates another embodiment of a filament type LED light source 200′ having a rectangular prism structure that includes four LED modules 100A, 100B, 100C, and 100D. Each of the four LED modules 100A, 100B, 100C, and 100D has a bar shape and is provided at a respective side surface of the rectangular prism structure.

The filament type LED light source 200′ may include a coupling member 110′ for fixing the four LED modules 100A, 100B, 100C, and 100D. The coupling member 110′ employed may be located, for example, at an edge of a side surface of the rectangular prism structure in order to allow adjacent LED modules to be coupled to each other in a manner similar to the example embodiment described previously. The rectangular prism structure may have an empty or hollow center.

In an example embodiment, the four LED modules 100A, 100B, 100C, and 100D may emit white light having different color temperatures or may emit light of different colors. In one embodiment, only some of the four LED modules 100A, 100B, 100C, and 100D may emit white light having a different color temperature or light of a different color. For example, two LED modules may emit white light in a range of 3700 K to 4300 K (for example, 4000 K) as main white light. The remaining two LED modules may emit white light in a range of 2300 K to 3000 K (for example, 2700 K) and white light in a range of 6400 K to 7000 K (for example, 6700 K), respectively. Selective switching may be applied to the remaining LED modules to change color temperature.

According to an example embodiment, the connection structure of the filament type LED light source 200′ may include four first connection portions 120 connected to first connection electrodes 80a of the four LED modules 100A, 100B, 100C, and 100D, respectively. The connection structure of the filament type LED light source 200′ may also include a second connection portion 130′ (a common connection portion) commonly connected to second connection electrodes 80b of the four LED modules 100A, 100B, 100C, and 100D.

The first connection portions 120 may include a clip at a first end of a rectangular prism structure. The second connection portion 130′ is a structure to be inserted onto a second end of the rectangular prism structure and may be understood, for example, with reference to the second connection portion 130 of FIG. 4.

Through this connection structure, the four LED modules 100A, 100B, 100C, and 100D may be selectively driven. As a result of this selective driving, an LED lamp may adjust the color temperature of illumination light, for example, based on a user's emotions or on various other criteria.

FIG. 11 illustrates another embodiment of an LED lamp 300′ which may include a base portion 210 having an external connection terminal 211, a light-transmitting cover 280 mounted on the base portion 210 and having the internal space 285, and a plurality of filament type LED light sources 100 in the internal space 285.

The LED lamp 300′ may have a similar structure to the example embodiment of FIG. 1, except that a filament type LED light source 200′ having a rectangular prism structure is provided as two filament type LED light sources, and a conductive frame is used without having a reflective prism structure.

As illustrated in FIG. 11, a prism structure 260′ for supporting a conductive frame may be disposed in a substantially central axis A of the internal space 285 of the light-transmitting cover 280. The prism structure 260′ may be formed of glass, hard glass, quartz glass, or light transmitting resin in a similar manner to the light-transmitting cover 280, and may allow light emitted from the filament type LED light source 200′ to be transmitted. The prism structure 260′ may include a common electrode 265.

The two filament type LED light sources 200′ may be arranged at regular intervals around the prism structure 260′. The two filament type LED light sources 200′ may be mounted on a top plate 218 of the base portion 210.

As described in the previous example embodiment, a first connection portion 120 may have a clip structure and may be mounted on the top plate 218 of the base portion 210. The first connection portion having the clip structure may be used, so the filament type LED light source 200′ may be supported. In an example embodiment, the four LED modules 100A, 100B, 100C, and 100D are provided as each of the two filament type LED light sources 200′, so a total of eight first connection portions 120 in the form of a clip may be provided to the top plate 218 of the base portion 210.

A second connection portion 130′ may be at an opposite side of the first connection portion 120, that is, at a second end of a rectangular prism structure. The second connection portion may be used as a common terminal commonly connected to second connection electrodes 80b of respective LED modules 100A, 100B, 100C, and 100D. While the second connection portions 130′ of the two filament type LED light sources may be connected to each other by a conductive frame 295, the second connection portions may be connected to the common electrode 265.

In the two filament type LED light sources 200′, the first connection electrode 80a of a total (eight) of LED modules may be respectively connected to a power supply portion through the first connection portion 120. The second connection electrode 80b of a total (eight) of LED modules may be commonly connected to a power supply portion through the second connection portion 130′ and the common electrode 265.

The controller and other signal generating and signal processing features of the disclosed embodiments may be implemented in logic which, for example, may include hardware, software, or both. When implemented at least partially in hardware, the controller and other signal generating and signal processing features may be, for example, any one of a variety of integrated circuits including but not limited to an application-specific integrated circuit, a field-programmable gate array, a combination of logic gates, a system-on-chip, a microprocessor, or another type of processing or control circuit.

When implemented in at least partially in software, the controller and other signal generating and signal processing features may include, for example, a memory or other storage device for storing code or instructions to be executed, for example, by a computer, processor, microprocessor, controller, or other signal processing device. The computer, processor, microprocessor, controller, or other signal processing device may be those described herein or one in addition to the elements described herein. Because the algorithms that form the basis of the methods (or operations of the computer, processor, microprocessor, controller, or other signal processing device) are described in detail, the code or instructions for implementing the operations of the method embodiments may transform the computer, processor, controller, or other signal processing device into a special-purpose processor for performing the methods herein.

In accordance with one or more of the aforementioned embodiments, a filament type LED light source includes LED modules that emit white light having different color temperatures combined in a polygonal prism structure. The LED lamp adjusts color temperature of illumination light based on various criteria, including but not limited to the requirements of various application requirements. In one embodiment, color temperature is based on or is adjusted to promote a user emotion. In one embodiment, the LED modules may emit light of different wavelengths that are combined. Thus, an LED lamp may be provided for adjusting the color of illumination light, the combined wavelength of illumination light, or both.

Example embodiments have been disclosed herein, and although specific terms are employed, they are used and are to be interpreted in a generic and descriptive sense only and not for purpose of limitation. In some instances, as would be apparent to one of skill in the art as of the filing of the present application, features, characteristics, and/or elements described in connection with a particular embodiment may be used singly or in combination with features, characteristics, and/or elements described in connection with other embodiments unless otherwise indicated. Accordingly, various changes in form and details may be made without departing from the spirit and scope of the embodiments set forth in the claims.

What is claimed is:

1. A filament type light emitting diode (LED) light source, comprising:
a plurality of LED modules arranged in a polygonal prism structure, the plurality of LED modules to emit white light having different color temperatures or light of different wavelengths, each of the plurality of LED modules having a bar shape at a respective side surface of the polygonal prism structure and including a first connection electrode and a second connection electrode;
a coupler to couple the plurality of LED modules in order to maintain the polygonal prism structure; and
a common connection portion at one end of the polygonal prism structure and commonly connected to the second connection electrode of each of the plurality of LED modules.

2. The filament type LED light source as claimed in claim 1, wherein each of the plurality of LED modules includes:
a substrate having a bar shape,
a plurality of LED chips mounted on the substrate and electrically connected to each other, and
a wavelength conversion portion on the plurality of LED chips.

3. The filament type LED light source as claimed in claim 2, wherein:
the wavelength conversion portion includes a wavelength conversion film on at least one surface of each of the plurality of LED chips, and
each of the plurality of LED modules includes a transparent resin portion on the substrate to cover the plurality of LED chips.

4. The filament type LED light source as claimed in claim 3, wherein:
the substrate includes a metal substrate, and
each of the plurality of LED modules includes an insulating layer in a chip mounting area of the metal substrate and a circuit pattern connecting the plurality of LED chips on the insulating layer.

5. The filament type LED light source as claimed in claim 3, wherein:
the substrate includes a transparent substrate, and
each of the plurality of LED modules includes a circuit pattern and a reflective layer, the circuit pattern located on an upper surface of the transparent substrate and connecting the plurality of LED chips, and the reflective layer located on a lower surface of the transparent substrate.

6. The filament type LED light source as claimed in claim 1, wherein the polygonal prism structure is a triangular prism structure or a rectangular prism structure.

7. The filament type LED light source as claimed in claim 6, wherein:
the polygonal prism structure is a triangular prism, and
each of the plurality of LED modules includes a first LED module to a third LED module to emit white light having different color temperatures.

8. The filament type LED light source as claimed in claim 1, wherein the coupler is at an edge of the polygonal prism structure to coupled adjacent ones of the plurality of LED modules.

9. The filament type LED light source as claimed in claim 8, wherein the polygonal prism structure has a hollow center.

10. An LED lamp, comprising:
a base portion having an external connection terminal;
a light-transmitting cover mounted on the base portion and having an internal space;
at least one filament type LED light source in the internal space and having a polygonal prism structure including a plurality of LED modules, the plurality of LED modules to emit white light having different color temperatures or light of different wavelengths, each of the plurality of LED modules coupled at a respective side surface of the polygonal prism structure and having a first connection electrode and a second connection electrode;
a power supply, in the base portion, to supply power to the plurality of LED modules; and
a driving controller, in the base portion, to control the power supply to allow at least one of the plurality of LED modules to be selectively driven, wherein the at least one filament type LED light source includes:
a coupler to couple the plurality of LED modules in order to maintain the polygonal prism structure,
a plurality of first connection portions at a first end of the polygonal prism structure and respectively connected to the first connection electrode of each of the plurality of LED modules and connected to the driving controller, and
a second connection portion at a second end of the polygonal prism structure and commonly connected to the second connection electrode of each of the plurality of LED modules and connected to the driving controller.

11. The LED lamp as claimed in claim 10, wherein:
the at least one filament type LED light source includes a plurality of filament type LED light sources, and
the plurality of filament type LED light sources are arranged symmetrically with respect to a central axis of the LED lamp.

12. The LED lamp as claimed in claim 11, further comprising:
a reflective prism on the central axis of the LED lamp and having a reflective surface.

13. The LED lamp as claimed in claim 12, wherein:
the reflective prism includes a common electrode connected to the driving controller, and
the second connection portion of each of the plurality of filament type LED light sources is electrically connected to the common electrode.

14. The LED lamp as claimed in claim 12, wherein:
a polygonal prism of the at least one filament type LED light source has an insertion hole with an empty center, and
the second connection portion has a protrusion portion inserted into the insertion hole and an electrode portion connected to the protrusion portion commonly connected to the second connection electrode of each of the plurality of LED modules.

15. The LED lamp as claimed in claim 10, wherein:
the plurality of first connection portions have a clip structure mounted on the base portion, and
the at least one filament type LED light source is fixed to the base portion using the clip structure.

16. The LED lamp as claimed in claim 15, further comprising:
a wire connecting an electrode portion of the second connection portion to a common electrode.

17. The LED lamp as claimed in claim 10, wherein:
the at least one filament type LED light source includes a plurality of filament type LED light sources;
each of the plurality of filament type LED light sources includes three or four LED modules to emit white light having different color temperatures, and
the polygonal prism structure is a triangular prism structure or a rectangular prism structure.

18. The LED lamp as claimed in claim 17, wherein:
while the power supply supplies power to one or more of the LED modules in each filament type LED light source, the driving controller is to control the power supply to selectively supply power to one or more of remaining ones of the plurality of LED modules.

19. The LED lamp as claimed in claim 18, wherein the driving controller is to adjust a duty ratio of a switching control signal for the remaining ones of the plurality of LED modules.

20. An LED lamp, comprising:
a base portion having an external connection terminal;
a light-transmitting cover mounted on the base portion, and having an internal space;
a reflective prism arranged along a central axis of the light-transmitting cover and having a common electrode formed in a direction of the central axis;
a plurality of filament type LED light sources around the reflective prism of the internal space, each of the plurality of filament type LED light sources including a plurality of LED modules arranged in a polygonal prism structure, the plurality of filament type LED light sources to emit white light having different color temperatures, each of the plurality of LED modules coupled at a respective side surface and having a first connection electrode and a second connection electrode;
a power supply, in the base portion, to supply power to the plurality of LED modules of each of the plurality of filament type LED light sources; and
a driving controller, in the base portion, to control the power supply to allow at least one of the plurality of LED modules to be selectively driven in each of the plurality of filament type LED light sources, wherein each of the plurality of LED filament light sources includes:
a plurality of first connection portions at a first end of the polygonal prism structure and respectively connected to the first connection electrode of each of the plurality of LED modules and connected to the power supply, and
a second connection portion at a second end of the polygonal prism structure and commonly connected to the second connection electrode of each of the plurality of LED modules and connected to the power supply portion through the common electrode.
